(19) United States
(12) Patent Application Publication
(10) Pub. No.: US 2023/0082508 A1
(43) Pub. Date: Mar. 16, 2023

(54) TOKENIZED BANDWIDTH AND NETWORK AVAILABILITY IN A NETWORK

(71) Applicant: Quixotic Holdings, LLC, Fife, WA (US)

(72) Inventor: Matthew David Perdew, Anchorage, AK (US)

(21) Appl. No.: 17/473,764

(22) Filed: Sep. 13, 2021

(51) Int. Cl. H04L 12/923; H04L 12/911; H04L 12/927

(52) U.S. Cl. CPC H04L 47/762; H04L 47/783; H04L 47/808; H04L 47/822; H04L 47/828

(57) ABSTRACT

Embodiments described herein are directed to utilizing a tokenized system to manage network bandwidth. A total network bandwidth availability is determined for a network, and a total number of tokens is determined for that total network bandwidth. The system also determines a total number of users for the network. When a user sends a network usage request to use or access the network, the system selects and allocates a number of tokens for the user based on the network usage request, the total number of network users, and the total number of tokens. The user's device can then access and use the network if the user has a sufficient number of available tokens for that usage. The number of tokens for the user is reduced based on the amount of data used by the user.

### BACKGROUND

### Technical Field

The present disclosure relates generally to information distribution management and, more particularly, to utilizing a tokenized bandwidth management system to use or access a network.

### Description of the Related Art

Mobile communication devices, such as smart phones, have become a very integral part in many peoples' lives. The number of mobile communication devices in use, and people's reliance thereon, continues to grow. For example, many people have a need to or expect to be able to connect to the Internet in a variety of different locations. To access the Internet, many mobile communication devices utilize a wireless network to connect with a service carrier, which allows devices to communicate with one another or to access the Internet. Many people subscribe to a network plan where they pay a fixed amount of money for a fixed or unlimited amount of data or bandwidth. People, however, may need additional data than their plan offers or may not utilize all of their plan's data. As a result, the network may suffer from inefficient use. It is with respect to these and other considerations that the following disclosure addresses.

### BRIEF SUMMARY

Briefly stated, embodiments described herein are directed to utilizing a tokenized system to manage network bandwidth. A total network bandwidth availability is determined for a network, and a total number of tokens is determined for that total network bandwidth. Namely, the network bandwidth availability can be sensed, calculated, or observed for a network. In addition, the total number of tokens can be sensed, calculated, or designated for that total network bandwidth. The system also receives data or makes inquiries, or both, across the network regarding the total number of users for the network at a particular point in time. The total number of users is can therefore be determined. When a user sends a network usage request to use or access the network, the system selects and allocates a number of tokens for the user based on the network usage request, the total number of network users, and the total number of tokens. The user's device can then access and use the network if the user has a sufficient number of available tokens for that usage. The number of tokens for the user can be reduced or increased based on the amount of data used by the user. In the alternative or in addition, the cost of a token to particular user can be increased or decreased depending on the bandwidth of the network, the data usage of that particular user, the type of data to be transmitted, characteristics of that user, or other transmission or user features.

By allocating and tracking tokens for network usage, the system can provide different tiers of token costs, as well as allow users to trade tokens based on usage, which can then be used to create a group databank for network bandwidth. As a result, the total network bandwidth can be utilized in a more efficient manner, while also providing standardized commodity prices for data usage, among other advantages.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following detailed description, which is to be read in association with the accompanying drawings:

FIG. 1 illustrates a block diagram of a communication network between user devices in accordance with embodiments described herein;

FIG. 2 illustrates a logical flow diagram showing one embodiment of a process for a computing system to allocate network bandwidth tokens to users of the network in accordance with embodiments described herein;

FIG. 3 illustrates a logical flow diagram showing one embodiment of a process for a computing system to manage network bandwidth token allocation for data usage requests in accordance with embodiments described herein; and

FIG. 4 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

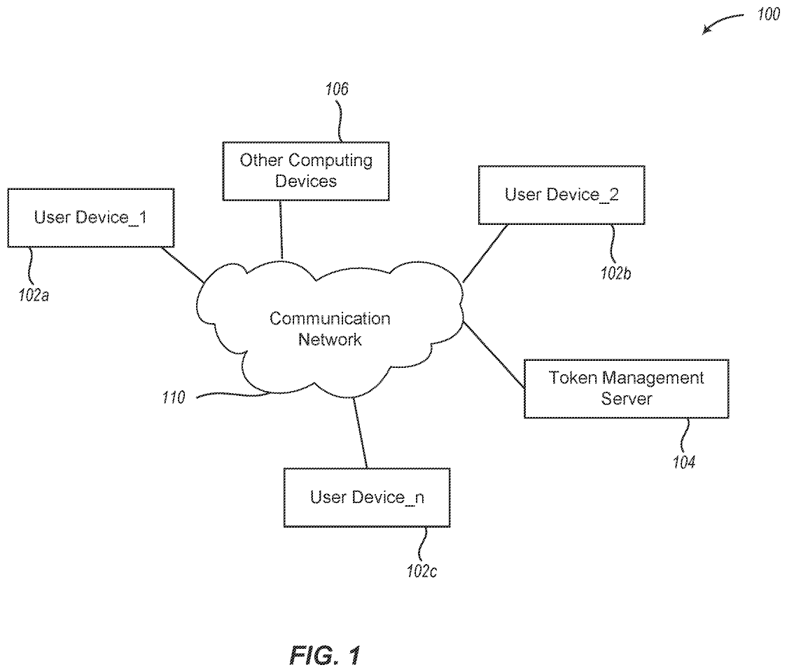

FIG. 1 illustrates a block diagram of a communication network 100 between user devices in accordance with embodiments described herein. Network 100 may include user devices 102a-102c, a token management server 104, and other computing devices 106, which communicate via communication network 110. Collectively, the user devices 102a-102c and the token management server 104, or the user devices 102a-102c and the token management server 104 and the other computing devices 106, may be referred to as the network. The communication network 110 may include one or more wired or wireless communication links, networks, or protocols that enable transmission of data between computing devices. Although FIG. 1 only illustrates three user devices, embodiments are not so limited and one or a plurality of user devices may be employed.

When a user device 102 joins the network 100, it communicates with the token management server 104 to obtain or have tokens allocated to the user device 102. These tokens are used by the user device to utilize or access the network 100. In various embodiments, the number of allocated tokens is dependent on the number of user devices 102 in the network and the available bandwidth across the network 100. The user device 102 provides corresponding compensation for the tokens that are allocated to it. The corresponding compensation can be a fixed amount per token or it can be set based on various different criteria. For example, different prices per token can be used for user devices that transmit data at different security levels. As another example, different types of users or user devices may provide different compensation, such as individuals versus corporations versus government.

After a user device 102 is allocated tokens, it can then provide data usage requests to use or access the network 100. In some embodiments, the data request is forwarded to the token management server 104 to process the request and authorize the user device 102 to access the network 100. The number of tokens needed to use or access the network 100 is dependent on the amount of data being requested—the greater the amount of data being requested, the more tokens needed to fulfill the data request. In response to fulfilling the request, the token management server 104 reduces the current allocation of tokens to that user device.

If a user device 102 does not have a sufficient allocation of tokens to fulfill the data usage request, the user device 102 or the token management server 104 can request tokens from other user devices 102. User devices can opt in or out to provide such additional tokens. If another one or more user devices 102 provide the additional tokens, either singularly or collectively, then the user device 102 can proceed with fulfilling the data usage request.

Although network 100 illustrates a single network, embodiments are not so limited. In some embodiments, user devices 102 may establish multiple different networks or sub-networks. Each of these separate networks may have its own token management server 104, or they may share a single token management server 104. Accordingly, in some embodiments, user devices 102 can have allocated tokens for their subnetworks, other subnetworks, for collectively across multiple subnetworks.

Moreover, in some embodiments, a group of plurality of user devices can collectively request to have tokens allocated to the group. The user devices in that group can then individually use those tokens to access the network. In various embodiments, a plurality of user devices may operate as a subnetwork and may use group allocated tokens to access the subnetwork, but individual user devices (or other smaller groups of user devices) may have a separate allocation of tokens to use or access other subnetworks.

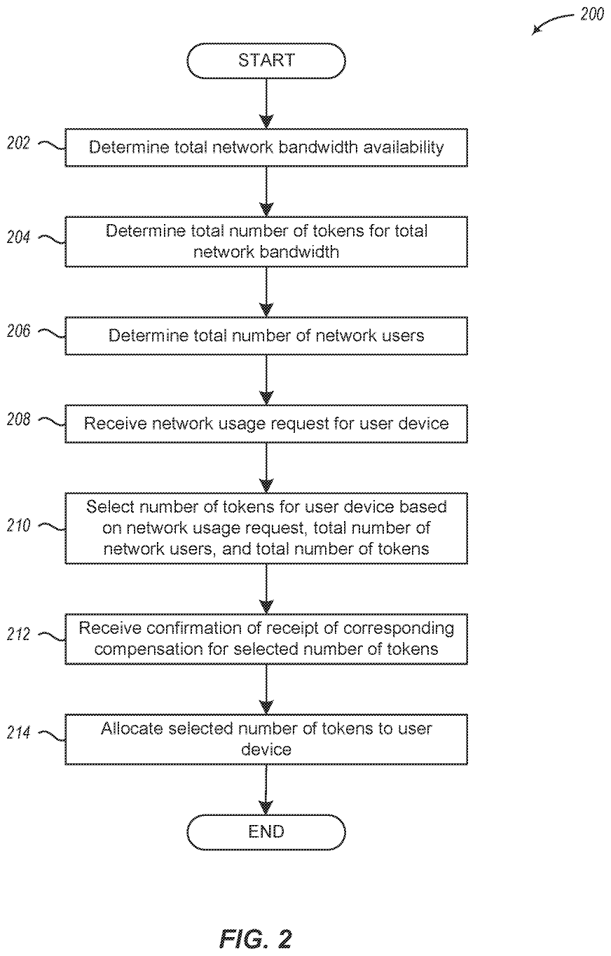

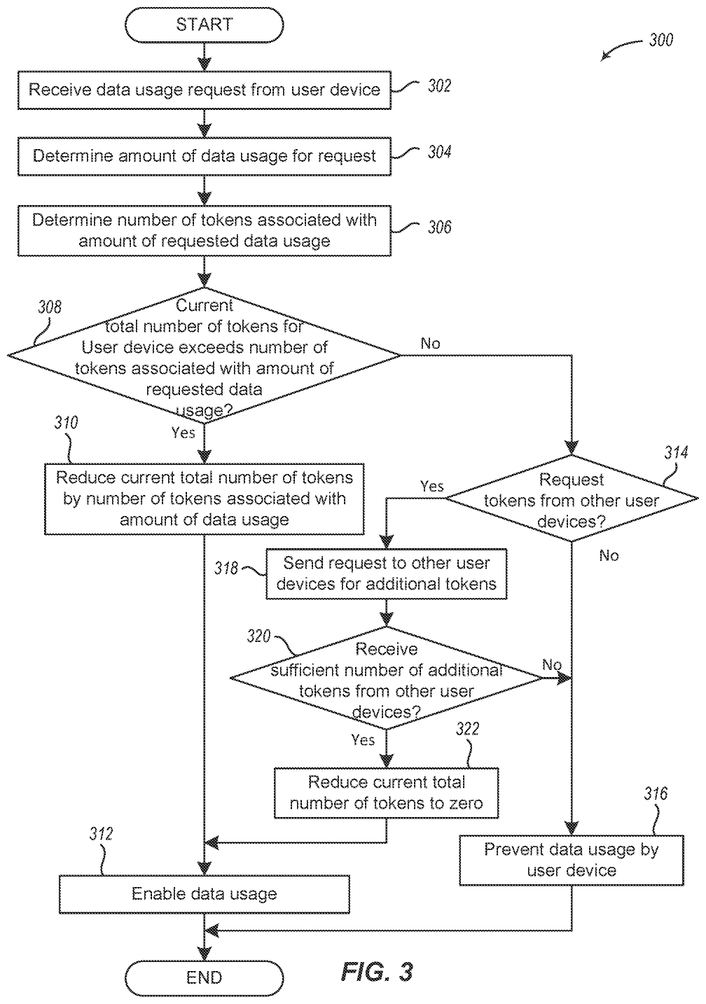

The operation of certain aspects will now be described with respect to FIGS. 2 and 3. In at least one of various embodiments, process 200 described in conjunction with FIG. 2 may be implemented by or executed on one or more computing devices, such as token management server 104 in FIG. 1. In some embodiments, process 300 described in conjunction with FIG. 3 may be implemented by or executed on one or more computing devices, such as token management server 104 or a corresponding user device 102 in FIG. 1.

FIG. 2 illustrates a logical flow diagram showing one embodiment of a process 200 for a computing system to allocate network bandwidth tokens to users of the network in accordance with embodiments described herein. Network bandwidth is used herein as a measure of data being transmitted from one computing device in the network to another computing device in the network. Although embodiments are described in terms of network bandwidth, embodiments are not so limited. Embodiments described herein can also be applied for network speed, quality of service, or other data transmission characteristic. Moreover, although embodiments are described in terms of selecting and allocating tokens for a user device, embodiments are not so limited. In some embodiments, the tokens may be selected for a user, independent of which user device that user is using. In this way, embodiments described herein can be used to allow the user to use and access the network from any user device using that user's tokens.

Process 200 begins, after a start block, at block 202, where a total network bandwidth availability is determined for a duration of time, namely the total network bandwidth availability is sensed, calculated, or observed by or provided to the system for that duration of time.

In some embodiments, the total network bandwidth may be sensed by different tests or data measurements applied to the network or the computing devices using the network or the transmissions between computing devices in the network. For example, the system may query or otherwise obtain the hardware capabilities of each computing device using the network. Those hardware capabilities can be analyzed by the system to determine the total available network bandwidth. In other embodiments, an administrator might set the total bandwidth, in which case, that set number can be sent to the system so that it is received and stored as data provided to it.

In some other embodiments, the total network bandwidth may be a combination of the physical characteristics of the network and the duration. The duration, for example, may be one week, one month, six months, or some other duration. The physical characteristics of the network may be how much data transfer the network itself can support at any given point in time. Various parameters and characteristics can be monitored and thus the network bandwidth can be determined—namely learned, sensed, calculated, or observed—by the collection of data and analyzing it.

In some embodiments, the physical characteristics of the network may based on a number of devices in the network and their capabilities. For example, if the network is expected to support 200 user devices, then the hardware and software capabilities of those devices can be utilized to determine the bandwidth availability of each device for any given point in time. That information is then aggregated to generate the total network bandwidth available for any given point in time.

In some situations, the total available network bandwidth may dynamically change based on changes to the network. For example, if the network is an ad hoc mesh network, then the physical characteristics of the network may change as user devices enter and exit the network. In at least one such embodiment, the physical characteristics of the mesh network may be estimated based on the projected number of user devices in the network and their projected capabilities. The bandwidth of the network might change over time depending on the network type and other factors. It might become larger or smaller as different characteristics change, including physical characteristics, such as adding servers or routing paths, or other characteristics, such as electrical, transmission, or workload factors that may change over time. Accordingly, the total network bandwidth availability for a duration of time may be based on an average or expected amount of available network bandwidth for the changing dynamics of the network.

Process 200 proceeds to block 204, where a total number of tokens is determined for the total network bandwidth available for the duration of time. In some embodiments, the total number of tokens may be collected, sensed, or learned based on a factor of the total network bandwidth, such as 500 tokens for each one gigabyte (GB) of available network bandwidth. In other embodiments, the total number of tokens may be set by an administrator. For example, the system can receive and store such data provided by the administrator. The system can then retrieve and utilize that data to learn, sense, calculate, or observe the number of tokens available, and thus determine the number of total tokens at a selected point in time. For some networks, the number of tokens may remain constant for a long periods of time or across multiple durations of time. But for other networks, the total number of available tokens may change from one duration of time to the next.

Process 200 continues to block 206, where a total number of network users is sensed, calculated, or observed for the duration of the total network bandwidth availability. In some embodiments, the total number of network users may be set by an administrator, such as a maximum number of possible users and this data is sent to the system and stored. In other embodiments, the total number of network users may be set as the total number of users that have signed up or registered to use the network. In some other embodiments, the total number of network users may sensed based on variations of the number of user devices connected to the network over time. For example, the system can track and store information indicating each time a user devices logs on or off the network, or a user device joins or leaves the network. In this way, the system can calculate the total number of current users when the logging information is retrieved by the system.

Process 200 proceeds next to block 208, where a network usage request is received for a user device. This request is for the user device to have the ability to access and utilize the network. In some embodiments, a user may log into a portal or send a request to the token management server to obtain tokens that can then be used to access or use the network. This network usage request may be received when the user signs up or otherwise becomes an authenticated user or the network, such as when the user establishes a network account. In at least one embodiment, the network usage request may be for a single data request for a limited amount of data.

In various embodiments, the request may include a total amount of network bandwidth that is being requested by the user device. This total amount of network bandwidth being requested may be the amount of data the user of the user device would like to use during a defined duration, such as a day, week, month, etc. This duration may be the same duration as identified for the total network bandwidth availability, as described above.

Process 200 continues next at block 210, where a number of tokens is selected for the user device. The number of tokens is selected based on the network usage request, the total number of network user devices, and the total number of tokens for the network. In some embodiments, the number of tokens selected is proportional to the amount of data requested in the network usage request relative to the total number of tokens for the network compared to the total amount of available network bandwidth.

Process 200 proceeds to block 212, where confirmation of receipt of corresponding compensation is received for the selected number of tokens. In various embodiments, an administrator of the network or token management server sets a compensation value per token or per group of tokens. For example, the administrator may set a dollar value of $0.50 per token. To receive the tokens, the user has to pay the corresponding compensation for the selected number of tokens.

In some embodiments, the compensation may be set at different levels for different level users, different security requirements, different types of users, or the like, or some combination thereof.

For example, assume the network operates on a three-tier security scheme: low-level for simple data transmission using the network (e.g., data transmission by the general public), mid-level for secure transmission of sensitive data (e.g., data transmission by police), and high-level for extra secure transmission of highly confidential data (e.g., data transmission by the military). The corresponding compensation may be set based on the security tier. For example, low-level security data transmission may cost $0.50 per token, mid-level security data transmission may cost $1.00 per token, and high-level security data transmission may cost $2.00 per token. In this way, the network can allocate resources and bandwidth more efficiently among users based on the security level required for the data transmission. Similarly, the network can be compensated for the extra hardware and software security resources needed to allow for the transmission of different levels of transmission security.

As another example, the government can be charged a higher price per token compared to corporations, and corporations can be charged a higher price per token compared to individuals, or vice versa.

Although these examples use three tiers or three different types of users, embodiments are not so limited and other numbers of tiers may be employed for different corresponding compensation for the selected number of tokens.

Moreover, changes in compensation by a user is not limited to a dollar value. In some embodiments, compensation may be provided as computing resources provided by the user device. For example, the user device can allot a specific amount of computing resources to operate as an intermediate device that can support the handling of data transmitted through the network. In this example, the user device is not an origination or destination device for the data being transmitted through the network, but providing network throughput support as compensation for tokens.

Process 200 continues at block 214, where the selected number of tokens are allocated to the user device in response to a positive confirmation of receipt of corresponding compensation for the selected tokens. If the corresponding compensation is not received, then the selected tokens are not allocated to that user device. In various embodiments, the token management server, or another computing device, maintains or stores records of the number of tokens allocated to each user device that can user or access the network.

After block 214, process 200 terminates or otherwise returns to a calling process to perform other actions.

FIG. 3 illustrates a logical flow diagram showing one embodiment of a process 300 for a computing system to manage network bandwidth token allocation for data usage requests in accordance with embodiments described herein.

Process 300 begins, after a start block, at block 302, where a data usage request is received from a user device. In various embodiments, this request is a specific request from the user device to transmit or receive data across the network, such as to access a website, send a message to another user device, receive a message from another user device, upload data to a server, etc. In some embodiments, the data usage request is for each individual data transmission to or from the user device, such as to send a message to another user device. In other embodiments, the data usage request is for a group of transmissions to or from the user device, such as to receive multiple transmissions to view a video on a website.

Process 300 proceeds to block 304, where an amount of data usage for the data usage request is determined. In some embodiments, the request may include the amount of data. For example, if the user is uploading a 1 GB movie to a server, then the data usage request may include a tag or other information indicating that the data usage is 1 GB. In other embodiments, the amount of data usage may be determined based on the type of data or the specific data being requested. For example, if the user is attempting to view a video that is 1 GB from a website, then the system can query the website to obtain the size of the video.

Process 300 continues at block 306, where an associated number of tokens is determined for the amount of data usage being requested. In various embodiments, the associated number of tokens may be proportional to the amount of data usage being requested relative to the number of tokens allocated to that user device for the total amount of network bandwidth requested when the corresponding compensation was provided. In various embodiments, the amount of data usage being requested may be an estimated amount data usage by the user device.

In some embodiments, the associated number of tokens may be determined based on the current status of the network. For example, if the network is experiencing higher latency than normal, or than what is expected, then the number of associated tokens for that requested data usage may be higher compared to if the network was experiencing normal latency.

In other embodiments, the associated number of tokens being requested may be determined based on the type of data being transmitting across the network. For example, low security data (e.g., a text message by the general public) may utilize one token per 10 megabytes (MB) of data usage, but medium security data (e.g., a radio transmission between emergency personnel) may utilize five tokens per 10 MB of data usage, and high security data (e.g., military personnel coordinates) may utilize 20 tokens per 10 MB of data usage.

Process 300 proceeds next to decision block 308, where a determination is made whether the current total number of tokens allocated for the user device exceeds the number of tokens associated with the requested amount of data usage. In some embodiments, this determination is a comparison between the user device's currently allocated tokens and the number of tokens determined at block 306. Accordingly, the currently available number of tokens is compared to the number of tokens that would be used by the requested action to be taken. As described in more detail below, as a user device uses and accesses the network, the total number of tokens allocated to the user device is reduced based on the amount of network data now being used. Thus, the current total number of allocated tokens may be less than the initial total allocated to the user.

If the user device has a number of allocated tokens that is greater than the number of tokens that will be needed for the requested amount of data usage for the data usage request, then process 308 flows to block 310; otherwise, process 300 flows to block 314.

At block 310, the current total number of tokens is reduced by the number of tokens associated with the amount of data usage. In various embodiments, this reduction in tokens is equal to the number of tokens requested at block 306. In some embodiments, this reduction may occur before the user device uses or accesses the network to fulfill the data usage request. In other embodiments, the token reduction may occur as the network is being used by the user device to transmit or receive data. Accordingly, the exact timing of when the token reduction occurs relative to the data usage may vary depending on different network parameters.

After block 312, the data usage for the request is enabled. In some embodiments, the token management server transmits a message to the user device or an intermediate computing device that is servicing the user device's request. This message authorizes the user device to fulfill the data usage request. In some embodiments, this message may include a tag or other identifier indicating that user device is authorized for the requested data usage. In some embodiments, the user device includes this tag in further transmissions associated with the data usage request to continue to indicate that it is authorized to fulfill the data usage request.

As mentioned above, the token reduction may occur before, during, or after data usage. If the actual data usage ends up using more or less data than what is requested at block 304, then additional tokens may be reduced from the user device's allocation or tokens may be added to the allocation. For example, if the user is requesting to watch a 1 GB video, but only 400 MB are received by the user device, then the total number of tokens allocated to the user device may be increased by a number of tokens that are associated with 600 MB (the difference between the actual 400 MB used and the estimated 1 GB). As another example, if the user is requesting to watch the 1 GB video, but the user device is continuously requesting retransmission of video data packets and 1.5 GB are transmitted to the user device, then the total number of tokens allocated to the user device may be further reduced by a number of tokens that are associated with 0.5 GB overage.

If, at decision block 308, the current total number of tokens for the user device does not exceed the number of tokens associated with the requested amount of data usage, then process 300 flows from decision block 308 to decision block 314.

At decision block 314, a determination is made whether or not to request additional tokens from other user devices. In some embodiments, some users or user devices may opt in to transmit, sell, or share tokens with other user devices. For example, a user may determine that they will not use all of their allocated tokens. That user can then opt in to share or sell their remaining tokens to a user who does not have sufficient tokens for a data usage request. In at least one embodiment, the user device that does not have a sufficient number of allocated tokens can opt in to requesting tokens from other user devices, or that user device may opt out such that no requests for additional tokens are made. If a request for additional tokens from other user devices is to be sent, then process 300 flows to block 318; otherwise, process 300 flows to block 316.

At block 318, the request for additional tokens is sent to one or more other user devices. In some embodiments, these other user devices may be selected from a plurality of user devices based on account preferences, network characteristics, or other factors associated with the devices, users, or network. For example, the other user devices may include the three user devices having a highest current number of allocated tokens. As another example, the other user devices may include the four user devices that are in communication with the user devices as part of a mesh network or subnetwork. In this way, user devices in a same mesh network or subnetwork can share tokens with other user devices in the same mesh network or subnetwork.

Process 300 proceeds next to decision block 320, where a determination is made whether a sufficient number of tokens has been received from the other user devices to fulfill the user device's request. This sufficient number of tokens is the difference between the number of tokens needed to fulfill the data usage request and the current number of tokens allocated to the user device making the request.

In some embodiments, the other user devices may automatically provide or transfer tokens to the user device. The number of tokens that are automatically transferred may be set by a user or distributed among the other user devices. This distribution may be uniform among the other user devices, or it may be proportional to the currently allocated number of tokens for each other user device. In other embodiments, users of the other user devices may be requested to actively indicate if they would like to provide one or more tokens to the user device, and if so, how many.

If a sufficient number of additional tokens are received to fulfill the data usage request, then process 300 flows to block 322; otherwise, process 300 flows to block 316.

At block 322, the current total number of tokens for the user device is reduced to zero. Moreover, the current number of allocated tokens for the other user devices that provided tokens to the user device is reduced by the number of tokens provided.

In various embodiments, the other user devices are compensated for the tokens that they provided to the user device. In some embodiments, this compensation is based on the corresponding compensation that other user device provided for the tokens. For example, if the other user device paid $0.50 for each token allocated to it and it provided four tokens to the user device, then that other user device is compensated $2 for the tokens.

In other embodiments, this compensation is based on the type of data being transmitted by the user device, the type of user device, the current network characteristics, etc., or some combination thereof. For example, if the data usage request is for highly secretive data, then the other user device may receive higher compensation per token than if the data usage request is for a non-sensitive text message. As another example, if the user device is a military unit, then the other user device may be compensated higher than if the user device is an individual civilian's user device.

In various embodiments, this compensation is paid for by the user device. Accordingly, the user device can indicate that it does not wish to pay for any additional tokens from other user devices.

After block 322, process 300 flows to block 312 to enable the data usage.

If, at decision block 314, additional tokens are not requested from other user devices, or if, at decision block 320, a sufficient number additional tokens are not received from the other user devices, then process 300 flows from decision block 314 and from decision block 320, respectively, to block 316.

At block 316, the data usage request by the user device is prevented. Accordingly, if the user device does not have enough tokens for the request and it cannot obtain tokens from other user devices, then the data usage request is denied.

After block 312 or after block 316, process 300 terminates or otherwise returns to a calling process to perform other embodiments. In some embodiments, process 300 may loop (not illustrated) to block 302 to receive another data usage request from the user device.

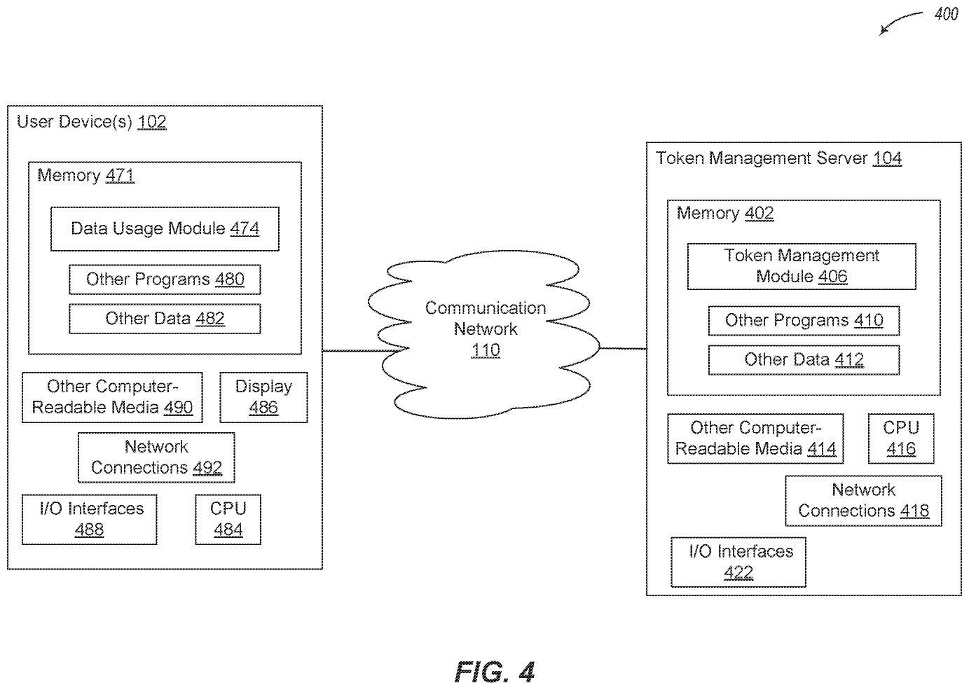

FIG. 4 shows a system diagram that describes one implementation of computing systems for implementing embodiments described herein. System 400 includes user device(s) 102 and token management server 104.

The user device(s) 102 communicate with one or more other user devices 102, collectively referred to as a network. The user device(s) 102 may also communicate with other computing devices or participants (not illustrated) of the network. The user device(s) 102 communicate with the token management server 104 via communication network 110 to request and have tokens allocated to each user device. The user device(s) 102 may also communicate with the token management server 104 to request additional tokens or to use tokens to utilize or access the network. One or more special-purpose computing systems may be used to implement each user device 102. Accordingly, various embodiments described herein may be implemented in software, hardware, firmware, or in some combination thereof. A user device 102 may include memory 471, one or more central processing units (CPUs) 484, display 486, other I/O interfaces 488, other computer-readable media 490, and network connections 492.

Memory 471 may include one or more various types of non-volatile and/or volatile storage technologies. Examples of memory 471 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 471 may be utilized to store information, including computer-readable instructions that are utilized by CPU 484 to perform actions, including embodiments described herein.

Memory 471 may have stored thereon data usage module 474, which operates to request tokens from the token management server 104, as well as to use tokens to utilize or access the network. The memory 471 may also store other programs 480 and other data 482. The other programs 480 may include user applications, operating systems, etc. For example, the or other programs 474 may communicate with the data usage module 474 to access the network to transmit or receive data. The other data 482 may include user device information, token information, network information, or other information.

Network connections 492 are configured to communicate with other computing devices, such as other user devices 102, token management server 104, or other computing devices, via communication network 110. Other I/O interfaces 488 may include a keyboard, audio interfaces, video interfaces, or the like. Other computer-readable media 490 may include other types of stationary or removable computer-readable media, such as removable flash drives, external hard drives, or the like. Display 486 is a display interface that is configured to output images, content, or information to a user. Examples of display 486 include, but are not limited to, LCD screens, LEDs or other lights, or other types of display devices.

Token management server 104 communicates with user devices 102 to allocate tokens to the user devices 102 or to authorize network usage or access via the tokens. One or more special-purpose computing systems may be used to implement the token management server 104. Accordingly, various embodiments described herein may be implemented in software, hardware, firmware, or in some combination thereof. The token management server 104 may include memory 402, one or more central processing units (CPUs) 416, I/O interfaces 422, other computer-readable media 414, and network connections 418.

Memory 402 may include one or more various types of non-volatile and/or volatile storage technologies. Examples of memory 402 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 402 may be utilized to store information, including computer-readable instructions that are utilized by CPU 416 to perform actions, including embodiments described herein.

Memory 402 may have stored thereon token management module 406. The token management module 406 may employ embodiments described herein to allocate and manage token usage by the user devices 102. The memory 402 may also store other programs 410, such as operating systems or other user applications, and other data 412. The other data 412 may store user device data or information, token allocation and usage, or other information.

Network connections 418 are configured to communicate with other computing devices, such as user devices 102 via communication network 110. Other I/O interfaces 422 may include a keyboard, audio interfaces, video interfaces, or the like. Other computer-readable media 414 may include other types of stationary or removable computer-readable media, such as removable flash drives, external hard drives, or the like. Communication network 110 may include one or more wired or wireless communication networks to transmit data between computing devices, such as user devices 102, token management server 104, and other computing devices.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
determining a total network bandwidth availability for a network;
determining a total number of tokens for the total network bandwidth;
determining a total number of users for the network;
receiving a network usage request from a user device for a user of the network;
selecting a number of tokens for the user device based on the network usage request, the total number of network users, and the total number of tokens; and
allocating the selected number of tokens to the user device.

2. The method of claim 1, further comprising:
receiving confirmation of receipt of compensation for the selected number of tokens prior to allocation of the selected number of tokens to the user device.

3. The method of claim 1, further comprising:
receiving a data usage request from the user device;
determining an amount of data usage by the user device based on the data usage request;
determining a number of tokens associated with the amount of data usage; and
reducing the allocated number of tokens to the user device by the determined number of tokens associated with the amount of data usage.

4. The method of claim 1, further comprising:
receiving a data usage request from the user device, the data usage request including an amount of data usage by the user device;
determining a number of tokens associated with the amount of data usage;
in response to the determined number of tokens being less than the allocated number of tokens to the user device, preventing the data usage by the user device.

5. The method of claim 1, further comprising:
receiving a data usage request from the user device, the data usage request including an amount of data usage by the user device;
determining a number of tokens associated with the amount of data usage;
in response to the determined number of tokens being greater than or equal to the allocated number of tokens to the user device, enabling the user device to access the network for the amount of data usage.

6. The method of claim 1, further comprising:
receiving a data usage request from the user device, the data usage request including an amount of data usage by the user device;
determining a number of tokens associated with the amount of data usage; and
in response to the determined number of tokens being less than the allocated number of tokens to the user device, requesting additional tokens from another user device.

7. The method of claim 6, wherein requesting the additional tokens from the other user device comprises:
requesting a number of tokens equal to a difference between the determined number of tokens associated with the amount of data usage and the allocated number of tokens to the user device.

8. The method of claim 6, further comprising:
in response to receiving the additional tokens from the other user device, enabling the user device to access the network for the amount of data usage.

9. The method of claim 6, further comprising:
in response to failing to receive the additional tokens from the other user device, preventing the data usage by the user device.

10. A computing device, comprising
a memory that stores computer instructions for a first participant; and
a processor that is configured to execute the computer instruction to:
determine a total network bandwidth availability for a network;
determine a total number of tokens for the total network bandwidth;
determine a separate number of tokens for each of the plurality of groups based on the total number of tokens;
receive a network usage request from a user device for a user of a first group of the plurality of groups;
select a number of tokens for the user device based on the separate number of tokens for the first group; and
allocate the selected number of tokens to the user device.

11. The computing device of claim 10, wherein the processor is configured to further execute the computer instructions to:
receive confirmation of receipt of compensation for the selected number of tokens prior to allocation of the selected number of tokens to the user device.

12. The computing device of claim 10, wherein the processor is configured to further execute the computer instructions to:
receive a request from the user device to utilize the network;
determine an amount of data usage requested by the user device;
determine a number of tokens associated with the amount of data usage; and
in response to the determined number of tokens being greater than or equal to the allocated number of tokens to the user device, enable the user device to utilize the network for the amount of data usage and reduce the allocated number of tokens to the user device by the determined number of tokens associated with the amount of data usage.

13. The computing device of claim 10, wherein the processor is configured to further execute the computer instructions to:
receive a request from the user device to utilize the network, the request including an amount of data usage;
determine a number of tokens associated with the amount of data usage;
in response to the determined number of tokens being less than the allocated number of tokens to the user device, prevent the user device from utilizing the network.

14. The computing device of claim 10, wherein the processor is configured to further execute the computer instructions to:
receive a request from the user device to utilize the network, the request including an amount of data usage;
determine a number of tokens associated with the amount of data usage; and
in response to the determined number of tokens being less than the allocated number of tokens to the user device, request additional tokens from another user device within the first group.

15. The computing device of claim 14, wherein the processor requests the additional tokens from the other user device by being configured to further execute the computer instructions to:
request a number of tokens equal to a difference between the determined number of tokens associated with the amount of data usage and the allocated number of tokens to the user device;
in response to receiving the additional tokens from the other user device, enable the user device to access the network for the amount of data usage; and
in response to failing to receive the additional tokens from the other user device, preventing the data usage by the user device.

16. A non-transitory computer-readable storage medium that stores instructions that, when executed by a processor in a computing system of a first participant, cause the processor to perform actions, the actions comprising:
determining a total network bandwidth availability for a network;
determining a total number of tokens for the total network bandwidth;
receiving a first network access request from a first user device for a first user of the network;
selecting a first number of tokens for the first user device based on the total number of tokens and the first network access request;
determining a first compensation amount for the first number of tokens for the first user;
in response to confirmation of receipt of the first compensation, allocating the first number of tokens to the first user device.

17. The non-transitory computer-readable storage medium of claim 16, wherein execution of the instructions by the processor cause the processor to perform further actions, the further actions comprising:
receiving a data request from the first user device to access the network;
determining a number of tokens for the data request; and
in response to the determined number of tokens being greater than or equal to the first number of tokens to the first user device, enabling the first user device to access the network for the data request and reducing the first number of tokens allocated to the first user device by the determined number of tokens for the data request.

18. The non-transitory computer-readable storage medium of claim 16, wherein execution of the instructions by the processor cause the processor to perform further actions, the further actions comprising:
receiving a data request from the first user device to access the network;
determining a number of tokens for the data request; and
in response to the determined number of tokens being less than the first number of tokens to the first user device, preventing the first user device from accessing the network for the data request.

19. The non-transitory computer-readable storage medium of claim 16, wherein execution of the instructions by the processor cause the processor to perform further actions, the further actions comprising:
receiving a second network access request from a second user device for a second user of the network;
selecting a second number of tokens for the second user device based on the total number of tokens and the second network access request;
determining a second compensation amount for the second number of tokens for the second user, wherein the second compensation per token is higher than the first compensation per token; and
in response to confirmation of receipt of the second compensation, allocating the second number of tokens to the second user device.

20. The non-transitory computer-readable storage medium of claim 19, wherein execution of the instructions by the processor cause the processor to perform further actions, the further actions comprising:
receiving a data request from the first user device to access the network;
determining a number of tokens for the data request;
in response to the determined number of tokens being less than the first number of tokens to the first user device, sending a request for additional tokens to the second user device;
in response to receiving a positive acknowledgement to provide the additional tokens from the second user device, enabling the first user device to access the network for the data request; and
in response to receiving a positive acknowledgement to provide the additional tokens from the second user device, preventing the first user device from accessing the network for the data request.
